(19) United States
(12) Patent Application Publication
(10) Pub. No.: US 2013/0053100 A1
(43) Pub. Date: Feb. 28, 2013

(54) MOBILE TERMINAL AND METHOD FOR CONTROLLING BARRIER PATTERN

(71) Applicants: Chang Jin SONG, Seoul (KR); Hong Kyu Kim, Seoul (KR)

(72) Inventors: Chang Jin SONG, Seoul (KR); Hong Kyu Kim, Seoul (KR)

(73) Assignee: PANTECH CO., LTD., Seoul (KR)

(21) Appl. No.: 13/598,447

(22) Filed: Aug. 29, 2012

(30) Foreign Application Priority Data
Aug. 31, 2011 (KR) 10-2011-0087768

(51) Int. Cl. G09G 5/00; H04W 88/02

(52) U.S. Cl. 455/556.1; 455/566; 345/156

(57) ABSTRACT

A mobile terminal includes a display unit to display a left-eye image and a right-eye image, a barrier panel to generate a parallax barrier region, and a barrier controller to adjust the parallax barrier region. A method for controlling a barrier pattern includes calculating a relative position of a barrier panel with respect to a display unit, adjusting a barrier region generated in the barrier panel according to the calculated relative position, and displaying a left-eye image and a right-eye image via the display unit.

### CROSS-REFERENCE TO RELATED APPLICATION

This application claims priority from and the benefit under 35 U.S.C. §119(a) of Korean Patent Application No. 10-2011-0087768, filed on Aug. 31, 2011, which is incorporated herein by reference for all purposes as if fully set forth herein.

### BACKGROUND

1. Field

The following description relates to a mobile terminal and a method for controlling a barrier pattern.

2. Discussion of the Background

A conventional folder type mobile phone may include a main display provided in the interior side of a lid. In order to identify information displayed on the main display, the folder is of a mobile phone may be opened to expose the main display. To reduce the inconvenience of opening the folder, a sub-display may be additionally installed to display information even in a folded state. The sub-display may be used to selectively offer pieces of information, which may be frequently checked by a user, including wireless signal reception intensity, residual capacity of battery, current time and date, etc.

In the conventional mobile phone, a main display and a sub-display may not be associated with each other to offer the respective pieces of information, and the information may be represented as two-dimensional (2D) data, which may be received via a transmission network. According to the recent proliferation of application fields using stereoscopic images, three-dimensional (3D) images may be provided using portable electronic devices, for example, mobile phones.

For the portable electronic devices, the implementation of 3D images may be mostly based on a glass-free manner. In the glass-free 3D implementation, a change in the field of vision may be caused according to the change in the position or the viewing angle of a 3D image display apparatus relative to a viewer. As the viewer's viewing position changes, a left-eye image may be reversed to a right-eye image, or vice versa, and a 3D effect may be deteriorated.

### SUMMARY

Exemplary embodiments of the present invention provide a mobile terminal and method for controlling a barrier pattern in a barrier panel.

Exemplary embodiments of the present invention also provide a correction method for controlling positions of barrier regions corresponding to a position deviation measured by a mobile terminal. The mobile terminal may determine relative positions of a first is display unit and a second display unit.

Additional features of the invention will be set forth in the description which follows and, in part, will be apparent from the description, or may be learned by practice of the invention.

Exemplary embodiments of the present invention provide a mobile terminal, including a display unit to display a left-eye image and a right-eye image; a barrier panel to generate a parallax barrier region; and a barrier controller to adjust the parallax barrier region.

Exemplary embodiments of the present invention provide a mobile terminal, comprising: a barrier panel to generate a parallax barrier region; a second display unit to display a left-eye image and a right-eye image; a connection unit to connect the barrier panel and the second display unit, and to provide a relative relocation of the barrier panel with respect to the second display unit; and a barrier controller to adjust the parallax barrier region based on a relative position of the barrier panel with respect to the second display unit.

Exemplary embodiments of the present invention provide a method for controlling a barrier pattern, including: calculating a relative position of a barrier panel with respect to a display unit; adjusting a barrier region generated in the barrier panel according to the calculated relative position; and displaying a left-eye image and a right-eye image via the display unit.

It is to be understood that both forgoing general descriptions and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention

FIG. 1 is a perspective view illustrating a mobile terminal according to an exemplary embodiment of the present invention.

FIG. 2 is a perspective view illustrating the mobile terminal shown in FIG. 1 when the folder is opened according to an exemplary embodiment of the present invention.

FIG. 3 is a vertical cross-sectional view of the mobile terminal shown in FIG. 1 taken along the line A-A′ according to an exemplary embodiment of the present invention.

FIG. 4 illustrates pixel patterns of a first display unit and a second display unit corresponding to a ‘B’ region shown in FIG. 3 according to an exemplary embodiment of the present invention.

FIG. 5A and FIG. 5B illustrate a mobile terminal to measure positions of the first display unit and the second display unit according to an exemplary embodiment of the present invention.

FIG. 6A and FIG. 6B illustrate a correction method when the first display unit and the second display unit are tilted or in a skewed orientation according to an exemplary embodiment of the present invention.

FIG. 7 is a perspective view illustrating a mobile terminal according to an exemplary embodiment of the present invention.

FIG. 8 is a perspective view illustrating a mobile terminal according to an is exemplary embodiment of the present invention.

FIG. 9A and FIG. 9B illustrate a method of sensing a tilt or a skewed orientation using an illumination sensor according to an exemplary embodiment of the present invention.

FIG. 10 is a perspective view illustrating a mobile terminal according to an exemplary embodiment of the present invention.

FIG. 11A and FIG. 11B illustrate a method of sensing a tilt or a skewed orientation using a touch sensor according to an exemplary embodiment of the present invention.

FIG. 12 is a perspective view illustrating a mobile terminal according to an exemplary embodiment of the present invention.

FIG. 13A and FIG. 13B illustrate a method of sensing a tilt or a skewed orientation using a camera according to an exemplary embodiment of the present invention.

FIG. 14 is a flowchart illustrating a method for adjusting a tilted position or a skewed orientation of multiple displays according to an exemplary embodiment of the present invention.

FIG. 15A and FIG. 15B are diagrams illustrating a mobile terminal to arrange a position of barrier regions according to an exemplary embodiment of the present invention.

### DETAILED DESCRIPTION OF THE ILLUSTRATED EMBODIMENTS

Exemplary embodiments now will be described more fully hereinafter with reference to the accompanying drawings, in which exemplary embodiments are shown. The present disclosure may, however, be embodied in many different forms and should not be construed as limited to the exemplary embodiments set forth therein. Rather, these exemplary embodiments are provided so that the present disclosure will be thorough and complete, and will fully convey the scope of the present disclosure to those skilled in the art. In the description, details of well-known features and techniques may be omitted to avoid unnecessarily obscuring the presented embodiments.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. It will be understood that for the purposes of this disclosure, “at least one of” will be interpreted to mean any combination the enumerated elements following the respective language, including combination of multiples of the enumerated elements. For example, “at least one of X, Y, and Z” will be construed to mean X only, Y only, Z only, or any combination of two or more items X, Y, and Z (e.g. XYZ, XZ, XZZ, YZ, X).

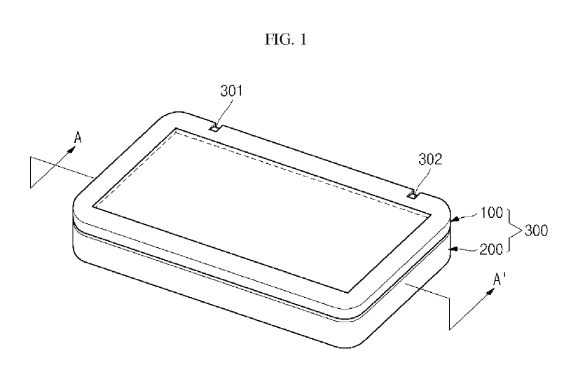

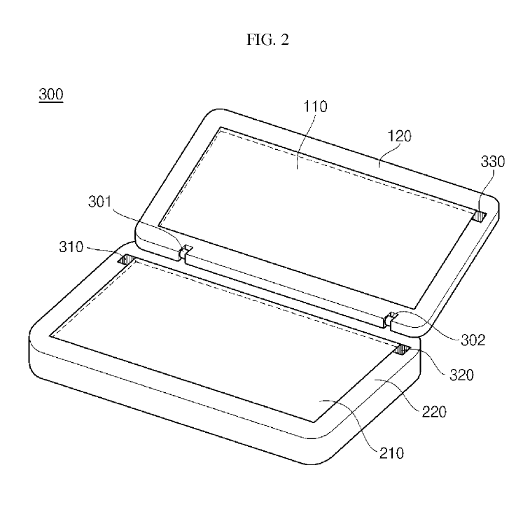

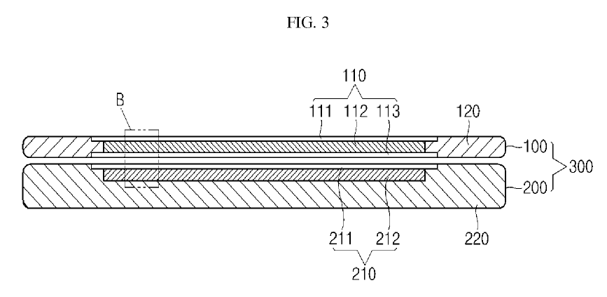

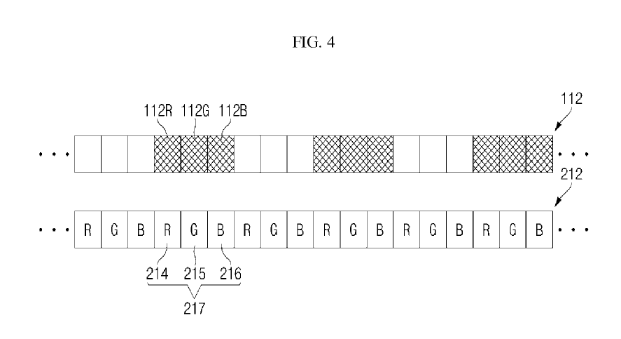

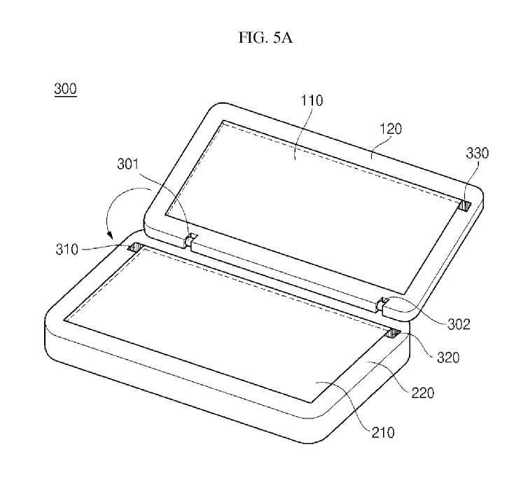

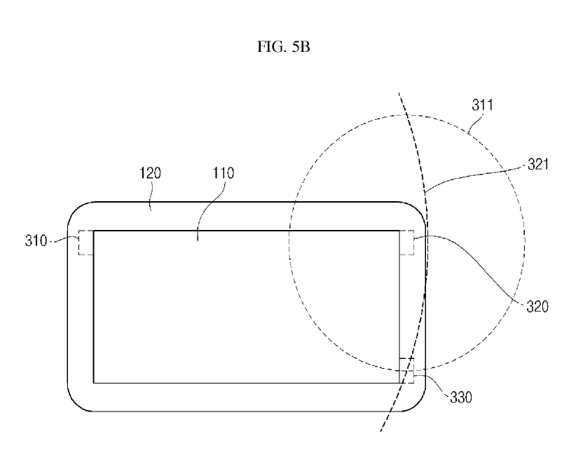

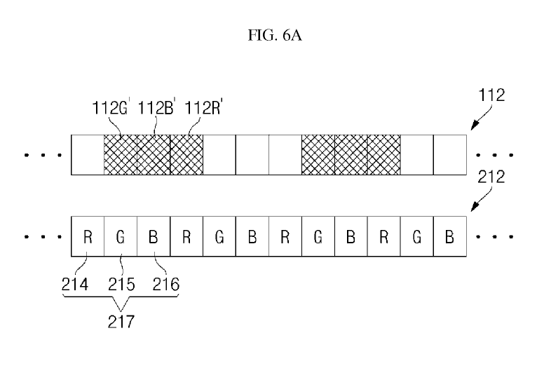

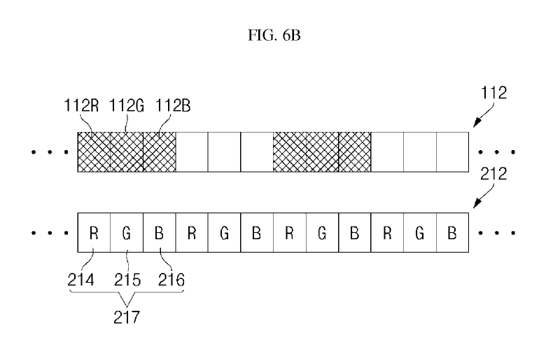

FIG. 1 is a perspective view illustrating a mobile terminal according to an exemplary embodiment of the present invention, FIG. 2 is a perspective view illustrating the is mobile terminal shown in FIG. 1 when the folder is opened according to an exemplary embodiment of the present invention, FIG. 3 is a vertical cross-sectional view of the mobile terminal shown in FIG. 1 taken along the line A-A′ according to an exemplary embodiment of the present invention, FIG. 4 illustrates pixel patterns of a first display unit and a second display unit corresponding to a ‘B’ region shown in FIG. 3 according to an exemplary embodiment of the present invention, FIG. 5A and FIG. 5B illustrate a mobile terminal to measure positions of the first display unit and the second display unit according to an exemplary embodiment of the present invention, and FIG. 6A and FIG. 6B illustrate a correction method when the first display unit and the second display unit are tilted or in a skewed orientation according to an exemplary embodiment of the present invention.

The mobile terminal 300 includes a first part 100 and a second part 200. In the mobile terminal 300, the first part 100 and the second part 200 are coupled to each other via one or more connection parts, such as hinges 301 and 302. The first part 100 and the second part 200 may be coupled via the hinges 301 and 302 such that the first part 100 may be folded to face a surface of the second part 200 or unfolded from the surface of the second part 200. In the mobile terminal 300, as shown in FIG. 3, when the first part 100 is folded around the hinges 301 and 302, the first display unit 110 and the second display unit 220 may be positioned to face each other.

The first part 100 may include a first display unit 110 and a first housing 120. Further, the first display unit 110 may include an upper protection layer 111, a barrier panel 112 and a lower protection layer 113.

The first housing 120 may be disposed to enclose the first display unit 110, and a first controller (not shown) may be disposed within the first housing 120 to control the first is display unit 110 and the second part 200 as described below.

The first display unit 110 may allow a viewer to recognize a displayed image as a 3D image. The displayed image may include a moving image, a still image, such as a photograph, and the like. The 3D image may include a moving image and a still image that may be perceived as 3D images by the viewer. The first display unit 110 may include a barrier panel 112 providing barrier regions formed to make a left-eye image and a right-eye image to be perceived differently by the viewer. A barrier pattern including multiple barrier regions may provide a stereoscopic image with a second display unit 210.

Referring to FIG. 4, the barrier panel 112 may include transparent pixels 112R, 112G and 112B through which light passes, and the pixels may include barrier regions to block the light if an electrical signal is received. The barrier regions may include barrier regions 112R, 112G and 112B located to corresponding pixels to selectively block light emitted from display elements 217 of an image display panel 212 to a certain direction. Further, protection layers 111 and 113 may be disposed on and under the barrier panel 112, respectively. The protection layers 111 and 113 may include one or more transparent regions.

Further, not only an image output from the second display unit 210 but also a real object image may be displayed as a 3D image via the barrier panel 112 using the barrier regions 112R, 112G and 112B. For example, as shown in FIG. 2, if the mobile terminal 300 is in an open position, the barrier panel 112 may display an augmented reality in which a real object may be combined with a virtual image through the first display unit 110 of the first part 100.

The second part 200 may include a second display unit 210 and a second housing 220. Further, the second display unit 210 may include an upper protection layer 211 and an image display panel 212.

The second housing 220 may be disposed to enclose the second display unit 210, and a second controller (not shown) may be disposed within the second housing 220 to control the first display unit 110 or the second display unit 210.

The second display unit 210 may include display elements 217 as electroluminescent elements to display an image. The image may include a moving image, a still image that may be perceived as 2D images or 3D images, and the like.

The image display panel 212 may be an organic light emitting diode (OLED) or a liquid crystal display (LCD), and the like. A transparent protection layer 211 may be disposed on the image display panel 212.

The image displayed on the image display panel 212 may be perceived by a viewer as a 3D image by the barrier panel 112. Since a left-eye image and a right-eye image are perceived by viewer's left eye and right eye, respectively, a stereoscopic 3D image may be recognized by the viewer. Further, as shown in FIG. 4, barrier regions 112R, 112G and 112B may be located to correspond to the display elements 217 of the image display panel 212. The display elements 217 may include a red (R) region 214, a green (G) region 215, and a blue (B) region 216. The barrier panel 112 may include barrier regions 112R, 112G, and 112B respectively corresponding to the red (R) region 214, the green (G) region 215, and the blue (B) region 216.

In a folder type mobile terminal 300, since the first part 100 may deviate from the original position, position measuring units 310 and 320 may be provided to detect position deviations of the first part 100 with respect to the second part 200.

Further, in the folder type mobile terminal 300, a position display unit 330 may be disposed on one part of the first part 100 and the second part 200, and position measuring units 310 and 320 may be disposed on the other part that does not include the position display unit 330 as shown in FIG. 2.

For example, in FIG. 5A, the position measuring units 310 and 320 are disposed on the second part 200 and the position display unit 330 is disposed on the first part 100. However, the positions of the position measuring units 310 and 320, and the position of the position display unit 330 are not limited as such.

Each of the position measuring units 310 and 320 may include a magnetic force sensor and may be positioned at either side of the second display unit 210. The magnetic force sensor may sense a position deviation, a tilt, or a skewed orientation based on a change in the magnetic force. The position display unit 330 may be disposed on the first housing 120 of the first part 100 and may include a magnet to generate a magnetic force and to allow the magnetic force sensor to sense the change in the magnetic force.

If the first part 100 is folded, the position measuring units 310 and 320 may start to sense the change in the magnetic force. The magnetic force sensed during the folded state of the first part 100 may be a reference magnetic force. The folding or unfolding of the first part 100 may move the position of the magnet included in the position display unit 330, and the position measuring units 310 and 320 disposed on the second part 200 may measure the change in the magnetic force generated by the magnet included in the position display unit 330 according to the movement of the magnet. The first part 100 may be an upper folder in a folder type mobile terminal or an upper sliding display unit in a sliding type mobile terminal. Further, the first part 100 may be a detachable device and may be configured to be connected to a mobile terminal via a connection port (not shown). For example, a user may want to connect the detachable first part 100 to a mobile terminal and utilize the mobile terminal to execute a 3D is providing contents, such as a 3D game and the like.

Referring to FIG. 5B, if the first part 100 is folded such that the first display unit 110 of the first part 100 is parallel to the second display unit 210 of the second part 200 as shown in FIG. 5B, the first position measuring unit 310 disposed on one region of the second display unit 210 may obtain an circle 311 corresponding to a magnetic force having a first reference magnitude. In FIG. 5B, the circle 311 ranges from the first position measuring unit 310 to a position of the magnet. Further, the second position measuring unit 320 may be spaced apart from the first position measuring unit 310. Referring to FIG. 5A, the first position measuring unit 310 and the second position measuring unit 320 may be positioned to be symmetrical with respect to a central axis (not shown). The second position measuring unit 320 may obtain a circle 321 corresponding to a magnetic force having a second reference magnitude. In FIG. 5B, the circle 321 ranges from the second position measuring unit 320 to a position of the magnet. For the mobile terminal 300, as shown in FIG. 5B, a reference state may be set to a matched position without a tilt or a skewed orientation. The reference state refers to a state in which the magnet of the position display unit 330 is positioned at a position at which the two circles 311 and 321 are crossed.

If a position deviation occurs due to various reasons, such as a tilt, a skewed orientation of the first part 100, and the like, the position measuring units 310 and 320 may sense the degree of the tilt or skewed orientation of the position display unit 330 from the matched position.

FIG. 6A shows pixel positions of a barrier panel 112 and an image display panel 212 when the first part 100 is tilted or in a skewed orientation. As shown in FIG. 6A, display elements 217 may be displayed in the order of red (R), green (G) and blue (B). If the barrier is panel 112 is positioned in a skewed orientation or tilted, left- and right-eye images may be perceived as incorrect 3D images.

FIG. 6A shows cross sections of pixel patterns of the first display unit 110 and the second display unit 210 when the first part 100 is tilted or in a skewed orientation. As shown in FIG. 6A, when barrier regions 112R′, 112G′ and 112B′ of a barrier panel 112 are not positioned at a matched position, quality of an output image may be lowered such that images are reversely viewed or a 3D effect is deteriorated. Therefore, in order to adjust the orientations of the first display unit 110 and the second display unit 210 from the positions shown in FIG. 6A to the matched position shown in FIG. 6B, a pixel of the barrier panel 112 corresponding to a red (R) region 214 of the image display panel 212 may be switched into a barrier portion by an electrical signal, and a pixel 112R′ corresponding to a barrier region in the barrier panel 112 may be switched into a transparent region, thereby adjusting positions of the barrier regions 112R, 112G and 112B to adjust the tilt or the skewed orientation. However, the arrangement of display elements of the image display panel 212 is not limited as such, for example, RGB. At least one of the first controller and the second controller may be capable of adjusting positions of the barrier regions. The tilt or the skewed orientation may be adjusted by sensing the mechanically tilted deviation or skewed orientation using the position measuring units 310 and 320 and automatically controlling the positions of the barrier regions using the controller based on the sensed deviation.

Multiple barrier regions including the barrier regions 112R′, 112G′ and 112B′ may be referred to as a barrier pattern. Specifically, the barrier panel 112 may include multiple barrier generating units. Each barrier generating unit may receive a control signal to generate a barrier region. If the control signal is not received by a barrier generating unit, the barrier is generating unit may not generate a barrier region and be transparent. Thus, according to control signals for barrier generating units, a barrier pattern including multiple barrier regions may be changed.

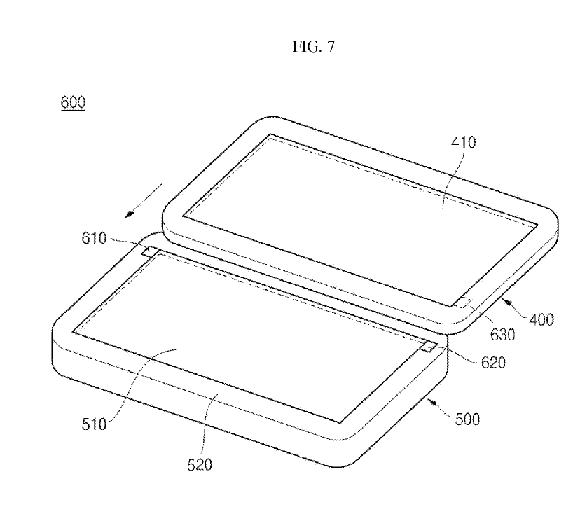

FIG. 7 is a perspective view illustrating a mobile terminal according to an exemplary embodiment of the present invention.

The mobile terminal 600 and the mobile terminal 300 shown in FIG. 2 may have substantially the same structure and functions except that mobile terminal 600 has a sliding structure rather than a folding structure. A first part 400 and a second part 500 may be opened or closed in a sliding manner. Accordingly, illustration of the same components and repeated descriptions thereof will be omitted.

The first part 400 and the second part 500 may be disposed to overlap with each other. If the first part 400 slides away from the second part 500 in an open position, a second display unit 510 of the second part 500 may be exposed. If the first part 400 slides to be overlapped on a top surface of the second part 500 in a closed position, measuring units 610 and 620 may detect whether a position deviation in which the first part 400 and the second part 500 are mechanically tilted or in a skewed positions occurs. In this case, each of the position measuring units 610 and 620 may include a magnetic force sensor and the position display unit 630 may include a magnet to adjust the position deviation.

As shown in FIG. 7, the position display unit 630 may be disposed on a location corresponding to the location of the position display unit 330 shown in FIG. 5B. Since the position measuring units 610 and 620 disposed in the second part 500 may be positioned at the same positions corresponding to the locations of the position measuring units 310 and 320 as shown in FIG. 5B, the mobile terminal 600 may slide into a closed position and may be is positioned at the same position as shown in FIG. 5B. Since the position measuring units 610 and 620 may sense positions of the position display unit 630 and a controller may control positions of barrier regions based on the sensed position deviation, the tilt or skewed orientation may be adjusted.

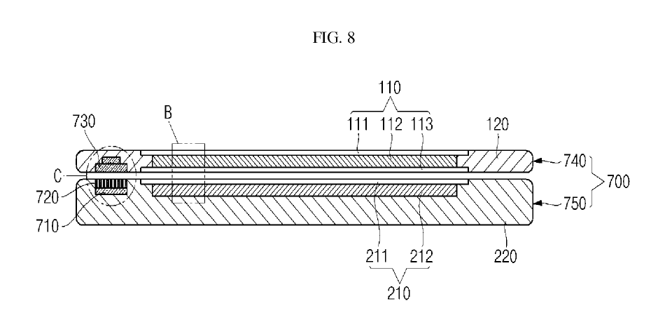

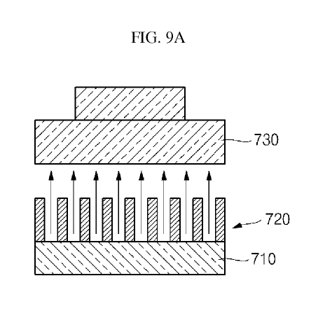

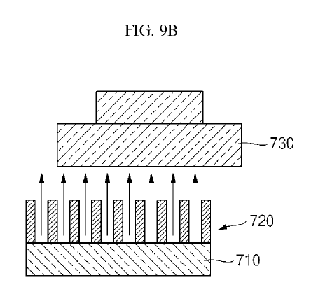

FIG. 8 is a perspective view illustrating a mobile terminal according to an exemplary embodiment of the present invention, and FIG. 9A and FIG. 9B illustrate a method for sensing a tilt or a skewed orientation using an illumination sensor.

The mobile terminal 700 may be similar to the mobile terminal 300 shown in FIG. 2 except for a position display units 710 and 720 and a position measuring unit 730. The mobile terminal 700 may be configured such that a first part 740 and a second part 750 coupled to each other may be a folder type as shown in FIG. 2 or a sliding type as shown in FIG. 7, but is not limited as such.

The position measuring unit 730 may measure the amount of light and may include an illumination sensor that senses a tilt, a position deviation, or a skewed orientation between the first part 740 and the second part 750. Referring to FIG. 9A, the illumination sensor may measure amount of light that passes through slits 720 disposed on a light emitting diode (LED) 710 that emits light. As shown in FIG. 9A, if the sensed amount of light of the LED 710 passing through the slits 720 is a reference value, the illumination sensor may determine that the first part 740 and the second part 750 are positioned at a matched position, and the reference value may be stored in a memory.

As shown in FIG. 9B, if the first part 740 is deviated, tilted, or skewed in orientation from the second part 750, the amount of light of the LED 710 sensed by the illumination sensor may be reduced. In this case, the position measuring unit 730 compares the is light amount with the stored reference value to measure the extent of a tilt, deviation, or skewed orientation. Since barrier regions can be controlled by a controller based on the measured deviation, tilt, or skewed orientation, the position of the barrier region can be adjusted.

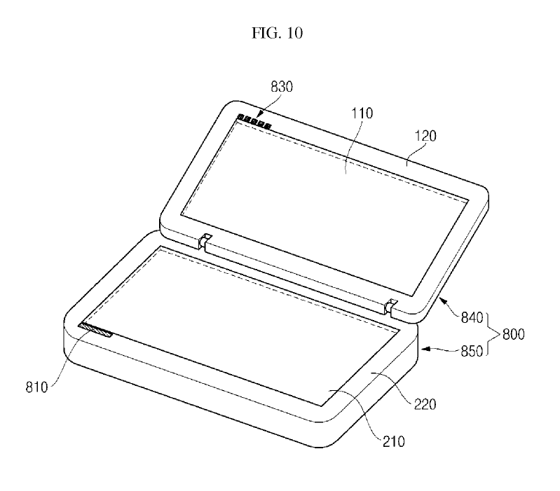

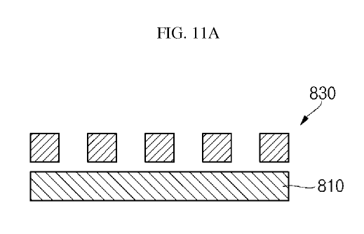

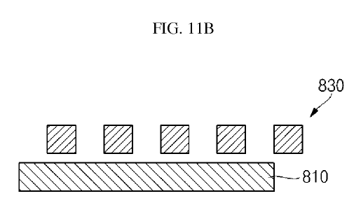

FIG. 10 is a perspective view illustrating a mobile terminal according to an exemplary embodiment of the present invention, and FIG. 11A and FIG. 11B illustrate a method for sensing a tilt, or skewed orientation using a touch sensor shown in FIG. 10.

The mobile terminal 800 may be similar to the mobile terminal 300 shown in FIG. 2 except for a position measuring unit 810 and a position display unit 830. The mobile terminal 800 may be configured such that a first part 840 and a second part 850 coupled to each other may be a folder type or a sliding type.

The position measuring unit 810 may include a touch sensor capable of measuring a position deviation of the first part 840 based on a variation in the capacitance, for example. In order to measure the variation in the capacitance, the touch sensor may include an electric conductor provided in contact with one surface thereof.

The position display unit 830 may include an electric conductor. If the mobile terminal 800 shown in FIG. 10 is a folder type device and is folded, electric conductors of the position display unit 830 and the position measuring unit 810 may contact with each other.

Referring to FIG. 11A, entire portions of the electric conductor of the position display unit 830 contacts the electric conductor of the position measuring unit 810, the capacitance value may be measured and stored as a reference capacitance value such that the position measuring unit 810 can determine that the first part 840 and the second part 850 are determined to be correctly aligned at a matched position if a measured capacitance value is identical to the reference capacitance value.

As shown in FIG. 11B, if the first part 840 is deviated from the second part 850, a contact area between the electric conductor of the position display unit 830 and the touch sensor may be reduced thus, capacitance value may be different from the reference capacitance value. The position measuring unit 810 may compare the reference capacitance value with the measured capacitance value to measure the extent of a tilt, a deviation, or a skewed orientation. Since barrier regions can be controlled by a controller based on the measured the tilt, the deviation, or the skewed orientation, the position of the barrier regions may be adjusted.

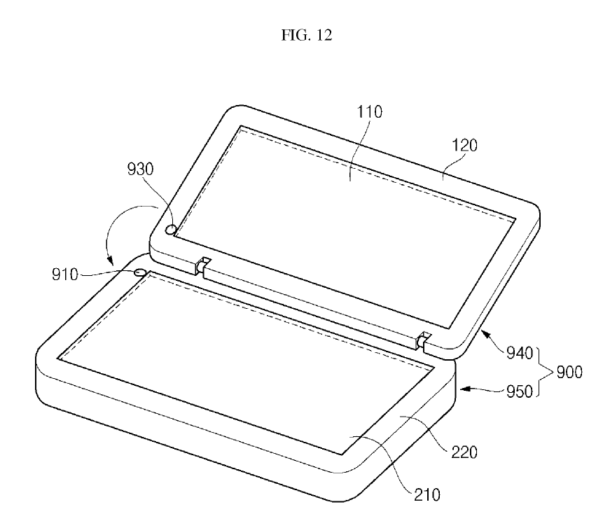

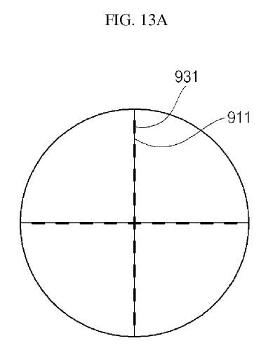

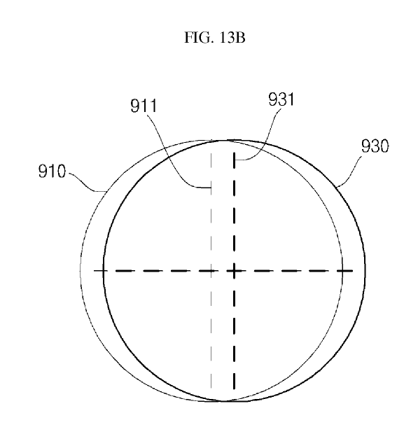

FIG. 12 is a perspective view illustrating a mobile terminal according to an exemplary embodiment of the present invention, and FIG. 13A and FIG. 13B illustrate a method for sensing a tilt, or a skewed orientation using a camera shown in FIG. 12.

The mobile terminal 900 may be similar to the mobile terminal 300 shown in FIG. 2 except for a position measuring unit 910 and a position display unit 930. The mobile terminal 900 may be configured such that a first part 940 and a second part 950 coupled to each other in a folder type or a sliding type, but is not limited as such.

The position measuring unit 910 may include a camera and the position display unit 930 may display guide lines 931. The guidelines 931 may include a horizontal guideline and a vertical guideline perpendicular to the horizontal guide line. The position measuring unit 910 may measure eccentricity in which the center at which the guide lines 931 of the position display unit 930 cross with each other does not coincide with a focus of the camera or a deviation vector. As shown in FIG. 13A, assuming that the center at which imaginary lines 911 cross with each other may be set as the focus of the camera, if the focus coincides with the center at which the guide lines 931 of the position display unit 930 cross with each other, reference position may be set such that it is determined that the first part 940 and the second part 950 are aligned at a correct matched position. As shown in FIG. 13B, if the first part 940 is deviated from the second part 950, the center at which the guide lines 931 of the position display unit 930 cross with each other (intersecting point of the guide lines 931) is deviated from the focus of the camera. The deviation vector may be calculated based on the two points, the intersecting point of the guide lines 931 and the focus of the camera. The position measuring unit 910 measures the eccentricity derived from a deviation from the focus of the camera, thereby measuring the extent of a tilt or a skewed orientation. Since the controller may control the barrier regions with respect to the measured eccentricity, the tilt or the skewed orientation can be adjusted.

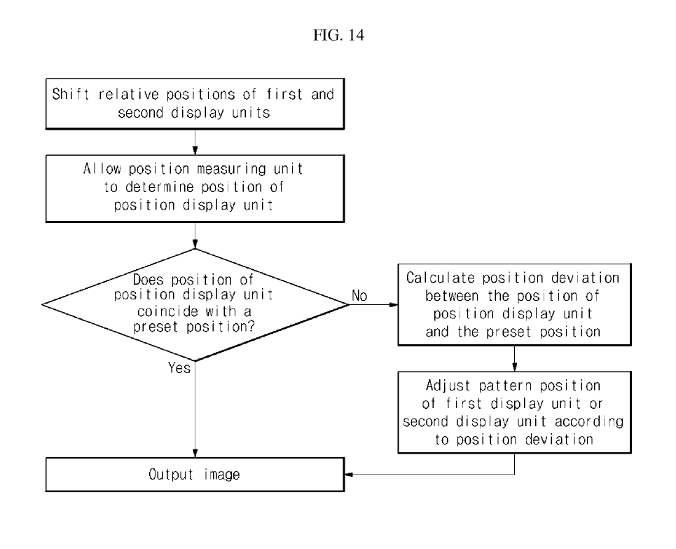

FIG. 14 is a flowchart illustrating a correction method for adjusting barrier regions according to an exemplary embodiment of the present invention.

The correction method according to an exemplary embodiment of the present invention may include setting a matched position (“a reference position”), determining a tilt, a deviation, or a skewed orientation caused by a relative position shift of the first part 100 with respect to the second part 200, and adjusting the position of barrier regions.

In the setting of the matched position, the first part 100 and the second part 200 may be coupled to each other, and the position display unit 330 may be set to be positioned at the matched position of the position measuring units 310 and 320 as the position of the first part 100 or the second part 200 is shifted. The set matched position may be reference data in determining whether there is a tilt, a deviation, or a skewed orientation.

After setting the matched position, the positions of the first part 100 and the second part 200 may be shifted. The shifting of the positions may include starting to shift the position of the first part 100 relative to the position of the second part 200, for example. In the mobile terminal 300, for example, the position of the first part 100 may be shifted in a variety of different operating manners, including a folder type, a slide type, and so on.

Further, the position measuring units 310 and 320 may determine whether a position of the position display unit 330 corresponds to the set matched position. If the position of the position display unit 330 corresponds to the set matched position, the positions of the barrier regions may not be changed and a 3D image may be output. If the position display unit 330 does not correspond to the set matched position, it may be determined that a tilt, a deviation, or a skewed orientation occurs.

If it is determined that a tilt, a deviation, or a skewed orientation occurs, the position of barrier regions in the first display unit 110 of the first part 100 may be adjusted based on a degree of the tilt, the deviation, or the skewed orientation from the matched position. The controller may control pattern positions (“positions of barrier regions”) to allow pixel patterns of the first display unit 110 and the second display unit 210 to be aligned at the matched position according to the position deviation measured by the position measuring units 310 and 320.

If the first display unit 110 includes a barrier panel 112 and the second display unit 210 includes an image display panel 212, the controller may control the patterns to be aligned at the matched position in the following manner.

The barrier panel 112 may be a transparent panel, and barrier regions may be formed at pixels to which electric signals are applied, thereby forming barrier patterns. Positions of the barrier patterns may be controlled by the controller using the electric signals applied to the barrier panel 112 to control the barrier patterns to be aligned at a matched position with respect to the pixels of the image display panel 212, thereby adjusting the skewed 3D image output. Barrier patterns may be adjusted in response to a relative position deviation of the first part 100 with respect to the second part 200, thereby adjusting quality of an output image in response to is the position deviation.

Further, exemplary embodiments of the present invention are not limited to parallax barriers. For example, lenticular lens may be included in the first part 100 to provide stereoscopic display images.

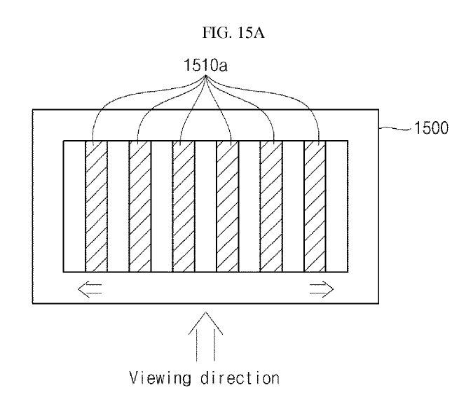

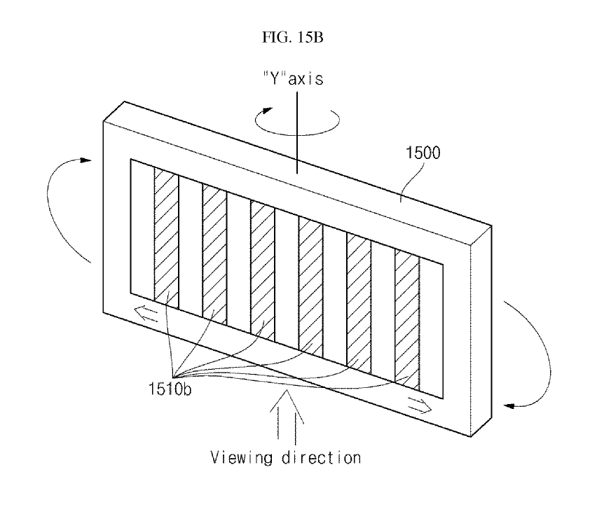

FIG. 15A is a diagram illustrating a mobile terminal to arrange a position of barrier regions according to an exemplary embodiment of the present invention. Referring to FIG. 15A, a mobile terminal 1500 may include a barrier panel to generate barrier regions 1510a. A user of the mobile terminal 1500 may view the mobile terminal 1500 from different viewing directions. Thus, the position of the barrier regions may be adjusted to provide a 3D image according to a viewing direction of the user. A user interface may be provided to shift the position of the barrier regions 1510a. For example, a user may touch the touch screen to change the position of the barrier panel 1510a in a manual control mode for changing the position of the barrier regions. In the manual control mode, the user may input a first touch input to move the position of the barrier regions to the left or a second input to move the position of the barrier regions to the right. The first and second input may be a dragging touch input to the left and right, respectively. As shown in FIG. 15A, the barrier regions 1510a may move to the left or to the right (“horizontal movement”). Further, a camera (not shown) may be provided on the mobile terminal 1500. The camera may capture an image including the user and may recognize the viewing direction of the user. A face recognition algorithm may be used to recognize the viewing direction of the user. The position of the barrier regions may be changed according to the viewing direction of the user.

FIG. 15B is a diagram illustrating a mobile terminal to arrange a position of barrier regions according to an exemplary embodiment of the present invention. Referring to FIG. 15B, the position of the mobile terminal 1500 may be changed due to various reasons. For example, if the user views the mobile terminal 1500 in a rocking vehicle, the position of the mobile terminal 1500 and the relative viewing direction may be constantly changing. Further, a user may want to move position of the mobile terminal 1500 while watching a 3D content. The 3D image quality may be deteriorated if the position of the barrier regions is fixed regardless of the relative change of the viewing direction. To address this problem, the position of the barrier regions 1510b may be changed according to a movement of the mobile terminal 1500. For example, the mobile terminal may include a sensor, such as a gyro sensor, to recognize the rotation of the mobile terminal 1500. Since the position of the barrier regions may be moved in the horizontal direction, the sensor may recognize the rotation of the mobile terminal 1500 with respect to the ‘Y’ axis parallel to each barrier region. The position of the barrier regions may be controlled based on the recognized rotation angle of the mobile terminal 1500.

As described above, since the mobile terminal includes a position display unit and a position measuring unit respectively formed in a first display unit and a second display unit coupled to each other, a position deviation between the first display unit and the second display unit can be measured.

In addition, the mobile terminal may improve quality of an output image by adjusting positions of pixel patterns corresponding to a position deviation measured using a mobile terminal capable of determining relative positions of a first display unit and a second display unit.

It will be apparent to those skilled in the art that various modifications and variation can be made in the present invention without departing from the spirit or scope of the invention. Thus, it is intended that the present invention cover the modifications and variations of is this invention provided they come within the scope of the appended claims and their equivalents.

What is claimed is:

1. A mobile terminal, comprising:
a display unit to display a left-eye image and a right-eye image;
a barrier panel to generate a parallax barrier region; and
a barrier controller to adjust the parallax barrier region.

2. The mobile terminal of claim 1, wherein the barrier controller adjusts the parallax barrier region based on a relative position of the barrier panel with respect to the display unit.

3. The mobile terminal of claim 1, wherein the barrier controller adjusts the parallax barrier region based on a movement of the barrier panel.

4. The mobile terminal of claim 1, wherein the barrier panel comprises:
a barrier generating unit to generate the parallax barrier region according to a control signal; and
a control signal receiving unit to receive the control signal.

5. The mobile terminal of claim 4, wherein the barrier generating unit is configured to be transparent if the parallax barrier region is not generated.

6. The mobile terminal of claim 1, wherein the barrier panel comprises multiple barrier generating units to generate a parallax barrier pattern comprising multiple parallax barrier regions.

7. The mobile terminal of claim 1, wherein the barrier panel comprises a first barrier generating unit to generate a first parallax barrier region and a second barrier generating unit to generate a second parallax barrier region,
wherein the first barrier generating unit generates the first parallax barrier region, and the second barrier generating unit eliminates the second parallax barrier region in response to a first control signal, and
the first barrier generating unit eliminates the first parallax barrier region, and the second barrier generating unit generates the second parallax barrier region in response to a second control signal.

8. The mobile terminal of claim 1, further comprising:
a position display unit to output a position indicating signal; and
a position measuring unit to sense the position indicating signal and to measure a tilt, a deviation, or a skewed orientation of the barrier panel with respect to the display unit.

9. The mobile terminal of claim 8, wherein the position indicating signal comprises at least one of a magnetic signal, a light signal, an electric charge signal, and an image signal.

10. The mobile terminal of claim 8, wherein the position measuring unit comprises at least one of a magnetic force sensor to sense a magnetic signal, an illumination sensor to sense a light signal, a touch sensor to measure a capacitive variation, and a camera to sense an image signal.

11. A mobile terminal, comprising:
a barrier panel to generate a parallax barrier region;
a second display unit to display a left-eye image and a right-eye image;
a connection unit to connect the barrier panel and the second display unit, and to provide a relative relocation of the barrier panel with respect to the second display unit; and
a barrier controller to adjust the parallax barrier region based on a relative position of the barrier panel with respect to the second display unit.

12. The mobile terminal of claim 11, further comprising:
a first display unit disposed on the barrier panel and configured to be transparent in a three-dimensional display mode, and
wherein the parallax barrier region is generated in the three-dimensional display mode.

13. The mobile terminal of claim 11, further comprising:
a position display unit to output a position indicating signal; and
a position measuring unit to sense the position indicating signal and to measure a tilt, a deviation, or a skewed orientation of the barrier panel with respect to the display unit.

14. The mobile terminal of claim 13, wherein the position indicating signal comprises at least one of a magnetic signal, a light signal, an electric charge signal, and an image signal.

15. The mobile terminal of claim 13, wherein the position measuring unit comprises at least one of a magnetic force sensor to sense a magnetic signal, an illumination sensor to sense a light signal, a touch sensor to measure a capacitive variation, and a camera to sense an image signal.

16. A method for controlling a barrier pattern, comprising:
calculating a relative position of a barrier panel with respect to a display unit;
adjusting a barrier region generated in the barrier panel according to the calculated relative position; and
displaying a left-eye image and a right-eye image via the display unit.

17. The method of claim 16, wherein relocating of the barrier region comprises:
generating a control signal to relocate the barrier region from a first region of the barrier panel to a second region of the barrier panel.

18. The method of claim 16, further comprising:
receiving an input to adjust the barrier region.

19. The method of claim 18, wherein the input is received from a user or from a controller according to a tilt, a deviation, or a skewed orientation of the barrier panel.

20. The method of claim 16, further comprising:
setting a matched position of the barrier panel and the display unit.
